(19) United States
(12) Patent Application Publication
(10) Pub. No.: US 2011/0223978 A1
(43) Pub. Date: Sep. 15, 2011

(54) COMMUNICATION DEVICE AND METHOD FOR ANSWERING INCOMING PHONE CALLS

(75) Inventor: CHIH-CHIEN CHU, Tu-Cheng (TW)

(73) Assignee: CHI MEI COMMUNICATION SYSTEMS, INC., Tu-Cheng City (TW)

(21) Appl. No.: 12/791,883

(22) Filed: Jun. 2, 2010

(30) Foreign Application Priority Data
Mar. 10, 2010 (TW) 99106836

(51) Int. Cl. H04B 1/38; H04M 1/00

(52) U.S. Cl. 455/567; 379/387.01

(57) ABSTRACT

A method and a communication device that includes a proximity sensor acquires a current distance between a user and the communication device when the communication device receives an incoming phone call. The method and the communication device establishes a communication with the incoming phone call and starts a speaker of the communication device to answer the incoming phone call, when the current distance is less than a preset threshold distance.

### BACKGROUND

1. Technical Field

Embodiments of the present disclosure relate generally to communication devices, and more particularly, to a communication device and method for answering incoming phone calls.

2. Description of Related Art

Many people answer incoming phone calls by using their hands to hold a communication device to their head. However, it may be dangerous to hold the communication device while answering a call in some situations, for example, while driving a car.

Therefore, there is a need for an improved communication device and method to address the above-mentioned problem.

### BRIEF DESCRIPTION OF THE DRAWINGS

FIG. 1 is a block diagram of one embodiment of a communication device.

FIG. 2 is a flowchart of one embodiment of a method for answering incoming phone calls of the communication device of FIG. 1.

FIG. 3 is a schematic diagram illustrating an example of the communication device with range of a proximity sensor.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

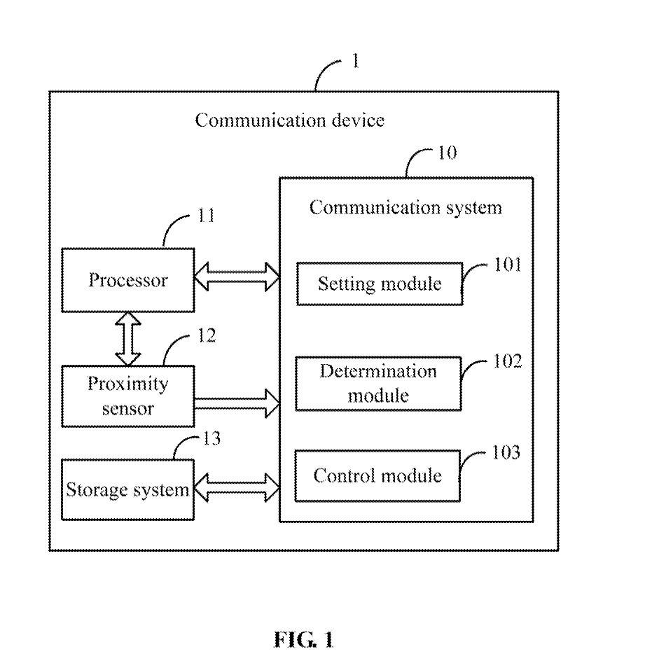

FIG. 1 is a block diagram of one embodiment of a communication device 1. In the embodiment, the communication device 1 may include a communication system 10, a processor 11, a proximity sensor 12, and a storage system 13. In one embodiment, the communication device 1 may be a mobile phone, a personal digital assistant, or other electronic devices. It should be apparent that FIG. 1 is only one example of the communication device 1 architecture that can be included with more or fewer components than shown in other embodiments, or a different configuration of the various components.

The processor 11 executes one or more computerized operations of the communication device 1 and other applications, to provide functions of the communication device 1. The storage system 13 stores one or more programs, such as programs of an operating system, and other applications of the communication device 1. In one embodiment, the storage system 13 may be random access memory (RAM) for temporary storage of information, and/or a read only memory (ROM) for permanent storage of information. In other embodiments, the storage system 13 may also be an external storage device, such as a hard disk, a storage card, or a data storage medium.

The proximity sensor 12 acquires a current distance between a user (or a part/portion of the user) and the communication device 1 in real-time, when the communication device 1 receives an incoming phone call. In one embodiment, the proximity sensor 12 can sense objects within a radial range. Assuming that the maximum sensing distance of the proximity sensor 12 is 1 meter (m), the proximity sensor 12 may sense all the objects in a radial range based on the maximum sensing distance. The radial range may be a sphere having the proximity sensor 12 as the center point of the sphere, with a lm radius. The part/portion of the user may include the one or more hands of the user, for example.

The communication system 10 may include a plurality of functional modules consisting of one or more computerized instructions that are stored in the storage system 13 or a computer-readable medium of the communication device 1, and executed by the processor 11 to perform operations of the communication device 1. In one embodiment, the communication system 10 includes a setting module 101, a determination module 102, and a control module 103. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The setting module 101 presets a threshold distance of the communication device 1, and stores the preset threshold distance in the storage system 13. The preset threshold distance can be set according to user requirements. In one embodiment, the preset threshold distance can be defined as, 10 cm, 15 cm or 25 cm, for example. If the threshold distance is not preset, a default distance may be defined as the preset threshold distance, such as 20 cm, for example. The preset threshold distance cannot be predefined if it is greater than a maximum distance, such as 30 cm, for example. The use of the preset threshold distance is described below.

The determination module 102 determines whether the current distance acquired by the proximity sensor 11 is less than the preset threshold distance.

The control module 103 controls the communication device 1 to establish a communication with the incoming phone call and starts a speaker of the communication device 1 to answer the incoming phone call in response to the current distance being less than the preset threshold distance.

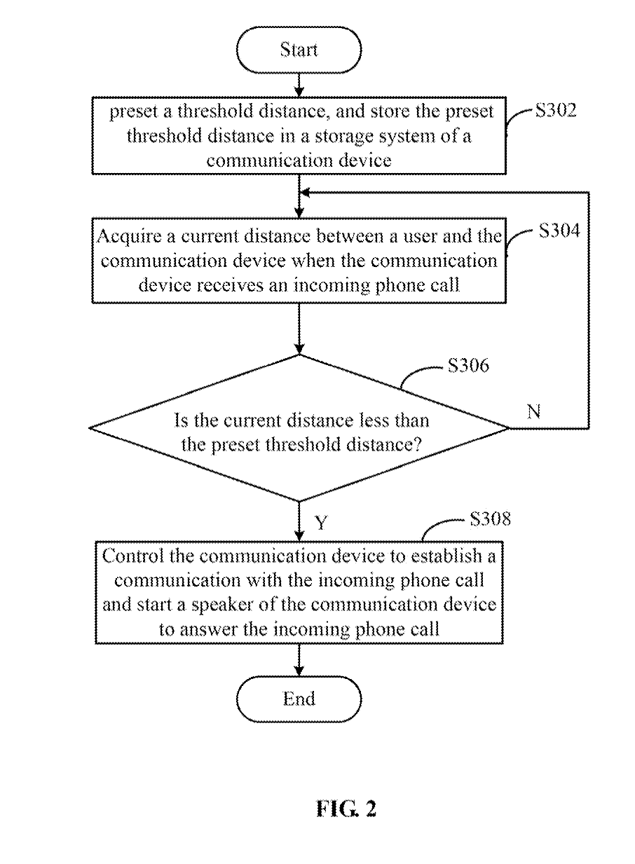

FIG. 2 is a flowchart of one embodiment of a method for answering incoming phone calls of the communication device 1 of FIG. 1. Depending on the embodiment, additional blocks may be added, others removed, and the ordering of the blocks, may be changed.

In block S302, the setting module 101 presets a threshold distance of the communication device 1, and stores the preset threshold distance in the storage system 13. The details of the preset threshold distance are mentioned above, and the use of the preset threshold distance is provided below.

In block S304, the proximity sensor 12 acquires a current distance between the user and the communication device 1 in real-time, when the communication device 1 receives an incoming phone call.

In block S306, the determination module 102 determines whether the current distance is less than the preset threshold distance, if the current distance is less than the preset threshold distance, block S308 is implemented, otherwise, block S304 is repeated if the current distance is not less than the preset threshold distance.

In block S308, the control module 103 controls the communication device 1 to establish a communication with the incoming phone call and starts a speaker of the communication device 1 to answer the incoming phone call.

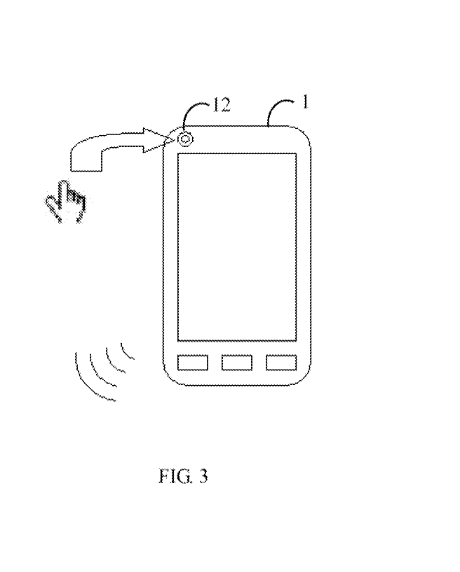

FIG. 3 is a schematic diagram illustrating an example of the communication device 1 within range of a proximity sensor 12. In one embodiment, the proximity sensor 12 can be installed in the communication device 1. In one example with respect to FIG. 3, a user can answer an incoming phone call by moving his/her hand towards the proximity sensor 12, whereupon the proximity sensor 12 senses a distance between the hand and the communication device 1 in real-time. The communication device 1 establishes a communication with the incoming phone call and starts a speaker of the communication device 1 to answer the incoming phone call, when the distance is less than the threshold distance preset by the user. As aforementioned, the user can answer the incoming phone call of the communication device 1 without holding the communication device 1, thereby avoiding the danger caused by answering incoming phone calls in some situations, for example, while the user is driving a car.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for answering incoming phone calls of a communication device, the communication device comprising a proximity sensor, the method comprising:
(a1) in response to the communication device receiving an incoming phone call, acquiring a current distance between a user and the communication device in real-time using the proximity sensor;
(a2) determining whether the current distance is less than a preset threshold distance, if the current distance is less than the preset threshold distance, step (a3) is implemented, otherwise, step(a1) is repeated if the current distance is not less than the preset threshold distance;
(a3) controlling the communication device to establish a communication with the incoming phone call and start a speaker of the communication device to answer the incoming phone call.

2. The method according to claim 1, further comprising:
presetting the threshold distance according to determined requirements; and
storing the preset threshold distance in a storage system of the communication device.

3. The method according to claim 1, wherein the communication device is a mobile phone or a personal digital assistant.

4. A communication device, the communication device comprising:
a proximity sensor operable to acquire a current distance between a user and the communication device in real-time, when the communication device receives an incoming phone call;
a storage system;
a communication system stored in the storage system, the communication system comprising:
a determination module operable to determine whether the current distance is less than a preset threshold distance; and
a control module operable to control the communication device to establish a communication with the incoming phone call and start a speaker of the communication device to answer the incoming phone call in response to the current distance being less than the preset threshold distance.

5. The communication device according to claim 4, wherein the communication system further comprises:
a setting module operable to preset the threshold distance according to determined requirements, and store the preset threshold distance in the storage system.

6. The communication device according to claim 4, wherein the communication device is a mobile phone or a personal digital assistant.

7. A storage medium storing a set of instructions, the set of instructions capable of being executed by a processor of a communication device, causing the communication device to perform a method for answering incoming phone calls, the method comprising:
(a1) in response to the communication device receiving an incoming phone call, acquiring a current distance between a user and the communication device in real-time using the proximity sensor;
(a2) determining whether the current distance is less than a preset threshold distance, if the current distance is less than the preset threshold distance, step (a3) is implemented, otherwise, step(a1) is repeated if the current distance is not less than the preset threshold distance;
(a3) controlling the communication device to establish a communication with the incoming phone call and start a speaker of the communication device to answer the incoming phone call.

8. The storage medium as claimed in claim 7, wherein the method further comprises:
presetting the threshold distance according to determined requirements; and
storing the preset threshold distance in a storage system of the communication device.

9. The storage medium as claimed in claim 7, wherein the communication device is a mobile phone or a personal digital assistant.
